(19) United States
(12) Patent Application Publication
(10) Pub. No.: US 2025/0266714 A1
(43) Pub. Date: Aug. 21, 2025

(54) PORTABLE BATTERY CHARGER FOR A LAUNDRY APPLIANCE

(71) Applicant: Haier US Appliance Solutions, Inc., Wilmington, DE (US)

(72) Inventors: MyungGeon Chung, Seoul (KR); Youn-Ki Min, YongIn (KR)

(21) Appl. No.: 18/582,188

(22) Filed: Feb. 20, 2024

(51) Int. Cl. H02J 50/10; D06F 34/04; D06F 39/12; D06F 105/44; D06F 105/58; H02J 7/00

(52) U.S. Cl. CPC H02J 50/10; D06F 34/04; D06F 39/12; H02J 7/0042; D06F 2105/44; D06F 2105/58

(57) ABSTRACT

A laundry appliance operating in a commercial laundromat includes a cabinet, a tub positioned within the cabinet, a basket rotatably mounted within the tub and defining a chamber configured for receiving a load of clothes, a door rotatably mounted to the cabinet for providing selective access to the chamber, and a battery charging assembly mounted to the cabinet. The battery charging assembly includes a docking station positioned on or within the cabinet, a charging pack removably received within the docking station, and a charging assembly operably coupled to the docking station and being configured for charging the charging pack when the charging pack is installed in the docking station.

### FIELD OF THE INVENTION

The present subject matter relates generally to laundry appliances, and more particularly to methods for providing cell phone chargers through a laundry appliance.

### BACKGROUND OF THE INVENTION

Laundry appliances are commonly used in shared use or pay-per-use commercial environments. For example, certain commercial laundry appliances, such as washing machines and clothes dryers within a laundromat, dormitory, or apartment building, are used by a large number of users. Similarly shared use arrangements are becoming more common in light of the rise of shared living arrangements, home rental services, and other shared appliance situations. In order to secure use of a particular laundry appliance for an operating cycle or laundry session, users often pay a fee for a particular number of cycles or a specific amount of laundry time for a particular laundry unit. For example, users commonly have software applications on their cell phones that are loaded with money or connected to a credit card for purchasing and commissioning one or more laundry appliances for use.

Notably, laundromat customers frequently use their phones during long washing or drying cycles. For example, the users may access work email, surf the web, play games, watch movies, etc. Additionally, there are many cases where laundromat customers hang around outside the laundromat until their laundry is finished. Notably, laundromat customers frequently run out of battery charge on their phones due to the heavy usage of their phones, particularly when wash/dry cycles are long or multiple cycles are run in succession. Accordingly, these users frequently need to charge their phones, but power outlets may be limited or not available at all.

Accordingly, systems and methods for charging cell phones of users of a commercial laundromat would be useful. In particular, a flexible and convenient method for charging cell phones would be particularly beneficial.

### BRIEF DESCRIPTION OF THE INVENTION

Aspects and advantages of the invention will be set forth in part in the following description, or may be obvious from the description, or may be learned through practice of the invention.

In one exemplary embodiment, a laundry appliance operating in a commercial laundromat is provided, including a cabinet, a tub positioned within the cabinet, a basket rotatably mounted within the tub and defining a chamber configured for receiving a load of clothes, a door rotatably mounted to the cabinet for providing selective access to the chamber, and a battery charging assembly mounted to the cabinet. The battery charging assembly includes a docking station positioned on or within the cabinet, a charging pack removably received within the docking station, and a charging assembly operably coupled to the docking station and being configured for charging the charging pack when the charging pack is installed in the docking station.

In another exemplary embodiment, a method of operating a laundry appliance in a commercial laundromat is provided. The laundry appliance includes a tub positioned within a cabinet, a door rotatably mounted to the cabinet for providing selective access to the tub, and a battery charging assembly mounted to the cabinet and comprising a docking station positioned on or within the cabinet, a charging pack removably received within the docking station, and a charging assembly operably coupled to the docking station and being configured for charging the charging pack when the charging pack is installed in the docking station. The method includes receiving a request to access the charging pack and unlocking the docking station to permit access to the charging pack.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a laundry appliance including a battery charging assembly according to an example embodiment of the present disclosure.

FIG. 2 provides a perspective view of a charging pack being removed from the example battery charging assembly of FIG. 1 according to an example embodiment of the present subject matter.

FIG. 3 provides a perspective view of the example charging pack of FIG. 1 charging a cell phone according to an example embodiment of the present subject matter.

FIG. 4 provides a perspective view of the example charging pack of FIG. 1 according to an example embodiment of the present subject matter.

FIG. 5 provides a method of operating a laundry appliance in a commercial laundromat according to an example embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

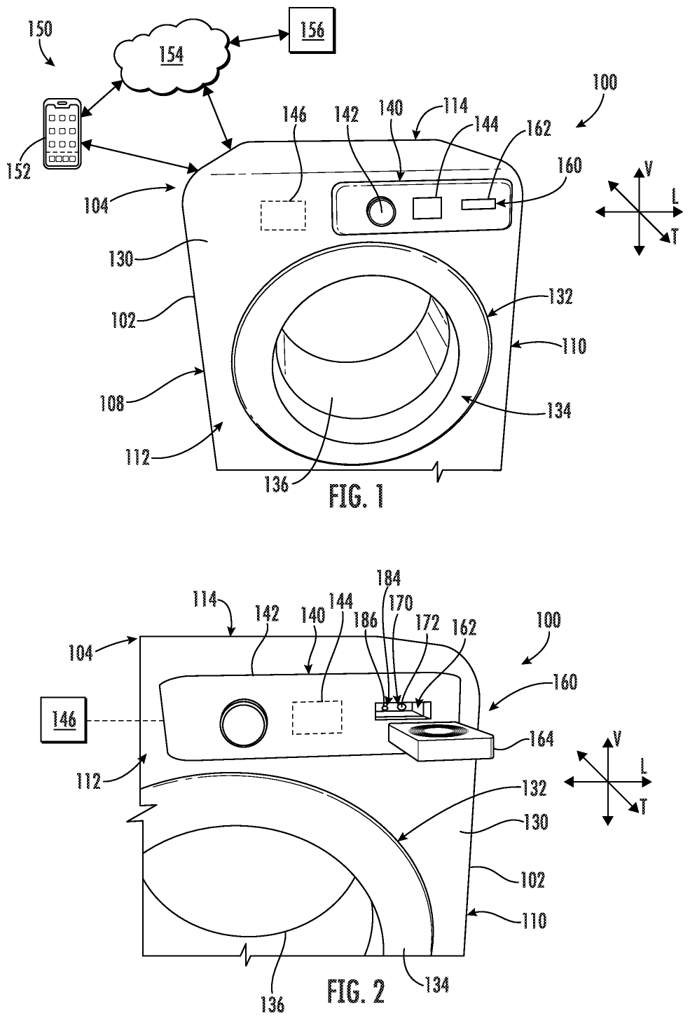

Referring now to FIGS. 1 through 3, an exemplary laundry appliance that may be used to implement aspects of the present disclosure will be described. According to exemplary embodiments, a washing machine appliance 100 includes a cabinet 102 that is generally configured for containing or supporting various components of washing machine appliance 100 and which may also define one or more internal chambers or compartments of washing machine appliance 100. In this regard, as used herein, the terms “cabinet,” “housing,” and the like are generally intended to refer to an outer frame or support structure for washing machine appliance 100, e.g., including any suitable number, type, and configuration of support structures formed from any suitable materials, such as a system of elongated support members, a plurality of interconnected panels, or some combination thereof. It should be appreciated that cabinet 102 does not necessarily require an enclosure and may simply include open structure supporting various elements of washing machine appliance 100. By contrast, cabinet 102 may enclose some or all portions of an interior of cabinet 102. It should be appreciated that cabinet 102 may have any suitable size, shape, and configuration while remaining within the scope of the present subject matter.

As illustrated, washing machine appliance 100 generally defines a vertical direction V, a lateral direction L, and a transverse direction T, each of which is mutually perpendicular, such that an orthogonal coordinate system is generally defined. In general, cabinet 102 extends between a top 104 and a bottom 106 along the vertical direction V, between a first side 108 (e.g., the left side when viewed from the front as in FIG. 1) and a second side 110 (e.g., the right side when viewed from the front as in FIG. 1) along the lateral direction L, and between a front 112 and a rear 114 along the transverse direction T. In general, terms such as “left,” “right,” “front,” “rear,” “top,” or “bottom” are used with reference to the perspective of a user accessing washing machine appliance 100. Further details regarding the operation of a washing machine appliance are known in the art and will be omitted here for brevity.

Referring still to FIGS. 1 through 3, cabinet 102 also includes a front panel 130 which defines an opening 132 that permits user access to a wash basket or a wash tub of washing machine appliance. More specifically, washing machine appliance 100 includes a door 134 that is positioned over opening 132 and is rotatably mounted to front panel 130. In this manner, door 134 permits selective access to opening 132 by being movable between an open position (not shown) facilitating access to the wash tub and a closed position (FIG. 1) prohibiting access to the wash tub.

A window 136 in door 134 permits viewing of the wash basket when door 134 is in the closed position, e.g., during operation of washing machine appliance 100. Door 134 also includes a handle (not shown) that, e.g., a user may pull when opening and closing door 134. Further, although door 134 is illustrated as mounted to front panel 130, it should be appreciated that door 134 may be mounted to another side of cabinet 102 or any other suitable support according to alternative embodiments. Washing machine appliance 100 may further include a latch assembly that is mounted to cabinet 102 or door 134 for selectively locking door 134 in the closed position or confirming that the door is in the closed position. The latch assembly may be desirable, for example, to ensure only secured access to the wash chamber or to otherwise ensure and verify that door 134 is closed during certain operating cycles or events.

During operation of washing machine appliance 100, laundry items are loaded into the wash basket through opening 132, and washing operation is initiated through operator manipulation of one or more input selectors or using a remote device (see below). The wash tub is filled with water, detergent, or other fluid additives, e.g., via a spout or detergent dispenser. One or more valves can be controlled by washing machine appliance 100 to provide for filling the wash basket to the appropriate level for the amount of articles being washed or rinsed. By way of example for a wash mode, once the wash basket is properly filled with fluid, the contents of the wash basket can be agitated (e.g., with ribs) for washing of laundry items in the wash basket.

After the agitation phase of the wash cycle is completed, the wash tub can be drained. Laundry articles can then be rinsed by again adding fluid to the wash tub, depending on the particulars of the cleaning cycle selected by a user. The ribs may again provide agitation within the wash basket. One or more spin cycles may also be used. In particular, a spin cycle may be applied after the wash cycle or after the rinse cycle in order to wring wash fluid from the articles being washed. During a final spin cycle, the wash basket is rotated at relatively high speeds and a drain assembly may discharge wash fluid from the sump. After articles disposed in the wash basket are cleaned, washed, or rinsed, the user can remove the articles from the wash basket, e.g., by opening door 134 and reaching into the wash basket through opening 132.

Referring again to FIG. 1, washing machine appliance 100 may include a control panel 140 that may represent a general-purpose Input/Output (“GPIO”) device or functional block for washing machine appliance 100. In some embodiments, control panel 140 may include or be in operative communication with one or more user input devices 142, such as one or more of a variety of digital, analog, electrical, mechanical, or electro-mechanical input devices including rotary dials, control knobs, push buttons, toggle switches, selector switches, and touch pads. Additionally, washing machine appliance 100 may include a display 144, such as a digital or analog display device generally configured to provide visual feedback regarding the operation of washing machine appliance 100. For example, display 144 may be provided on control panel 140 and may include one or more status lights, screens, or visible indicators. According to exemplary embodiments, user input devices 142 and display 144 may be integrated into a single device, e.g., including one or more of a touchscreen interface, a capacitive touch panel, a liquid crystal display (LCD), a plasma display panel (PDP), a cathode ray tube (CRT) display, or other informational or interactive displays.

Washing machine appliance 100 may further include or be in operative communication with a processing device or a controller 146 that may be generally configured to facilitate appliance operation. In this regard, control panel 140, user input devices 142, and display 144 may be in communication with controller 146 such that controller 146 may receive control inputs from user input devices 142, may display information using display 144, and may otherwise regulate operation of washing machine appliance 100. For example, signals generated by controller 146 may operate washing machine appliance 100, including any or all system components, subsystems, or interconnected devices, in response to the position of user input devices 142 and other control commands. Control panel 140 and other components of washing machine appliance 100 may be in communication with controller 146 via, for example, one or more signal lines or shared communication busses. In this manner, Input/Output (“I/O”) signals may be routed between controller 146 and various operational components of washing machine appliance 100.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 146 may be constructed without using a microprocessor, e.g., using a combination of discrete analog or digital logic circuitry (such as switches, amplifiers, integrators, comparators, flip-flops, OR gates, and the like) to perform control functionality instead of relying upon software.

Controller 146 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor of controller 146 or may be included onboard within such a processor. In addition, these memory devices can store information or data accessible by the one or more processors of controller 146, including instructions that can be executed by the one or more processors. It should be appreciated that the instructions can be software written in any suitable programming language or can be implemented in hardware. Additionally, or alternatively, the instructions can be executed logically or virtually using separate threads on one or more processors.

For example, controller 146 may be operable to execute programming instructions or micro-control code associated with an operating cycle of washing machine appliance 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 146 as disclosed herein is capable of and may be operable to perform one or more methods, method steps, or portions of methods of appliance operation.

The memory devices of controller 146 may also store data that can be retrieved, manipulated, created, or stored by the one or more processors or portions of controller 146. The data can include, for instance, data to facilitate performance of methods described herein. The data can be stored locally (e.g., on controller 146) in one or more databases or may be split up so that the data is stored in multiple locations. In addition, or alternatively, the one or more database(s) can be connected to controller 146 through any suitable network(s), such as through a high bandwidth local area network (LAN) or wide area network (WAN). In this regard, for example, controller 146 may further include a communication module or interface that may be used to communicate with one or more other component(s) of washing machine appliance 100, controller 146, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

Referring again to FIG. 1, a schematic diagram of an external communication system 150 will be described according to an exemplary embodiment of the present subject matter. In general, external communication system 150 is configured for permitting interaction, data transfer, and other communications between multiple discrete devices, such as a laundry appliance or more remote user devices. For example, this communication may be used to provide and receive operating parameters, user instructions or notifications, user preferences, or any other suitable information for engagement with washing machine appliance 100. In addition, it should be appreciated that external communication system 150 may be used to transfer data or other information to improve user interaction with laundry appliance or one or more remote user devices.

For example, external communication system 150 may permit controller 146 of washing machine appliance 100 to communicate with a separate device external to washing machine appliance 100, referred to generally herein as a remote user device 152. As described in more detail below, these communications may be facilitated using a wired or wireless connection, such as via a network 154. In general, remote user device 152 may be any suitable device separate from washing machine appliance 100 that is configured with an owner account to provide or receive communications, information, data, or commands from a user. In this regard, remote user device 152 may be, for example, a personal phone, a smartphone, a tablet, a laptop or personal computer, a wearable device, a smart home system, or another mobile or external device.

In addition, a remote server 156 may be in communication with washing machine appliance 100 or remote user device 152 through network 154. In this regard, for example, remote server 156 may be a cloud-based server 156, and is thus located at a distant location, such as in a separate state, country, etc. Generally remote server 156 may include a controller (not shown) that may be the same or similar to controller 146 described above. According to an exemplary embodiment, remote user device 152 may communicate with remote server 156 over network 154, such as the Internet, to transmit/receive data or information, provide user inputs, receive user notifications or instructions, interact with or control washing machine appliance 100, etc. In addition, remote user device 152 and remote server 156 may communicate with washing machine appliance 100 to communicate similar information.

According to an example embodiment, the remote user device 152 may include or be able to access a software application for interacting with the laundromat appliances. For instance, the remote user device 152 may be provided or associated with a particular user profile (e.g., an owner account) to interact with and operate each of the laundromat appliances. Using this software application, the user may maintain an account balance for paying for the use of laundromat appliances, may interact with and control such appliances, etc. For instance, the remote user device 152 may be provided or associated with a particular user profile (e.g., a consumer account) to interact with and operate each of the laundromat appliances. Such a profile may include physical or digital wallets that contain credits (e.g., coupons, tokens, or digital currency) for performing one or more cycles of the various washers and dryers within a laundromat. Remote server 156 may be in communication with remote user device 152 through network 154.

External communication system 150 is described herein according to an exemplary embodiment of the present disclosure. However, it should be appreciated that the exemplary functions and configurations of external communication system 150 provided herein are used only as examples to facilitate description of aspects of the present disclosure. System configurations may vary, other communication devices may be used to communicate directly or indirectly with one or more associated appliances, other communication protocols and steps may be implemented, etc. These variations and modifications are contemplated as within the scope of the present disclosure.

While described in the context of a specific embodiment of horizontal axis washing machine appliance 100, using the teachings disclosed herein it will be understood that horizontal axis washing machine appliance 100 is provided by way of example only. Other laundry appliances having different configurations, different appearances, or different features may also be utilized with the present subject as well. Such laundry appliances may include a vertical axis washing machine appliance, dryer appliance, combined washer/dryer appliance, etc., as would be understood in light of the present disclosure.

Referring still to FIG. 1, washing machine appliance 100 may be utilized as a commercial washer in a laundromat or another commercial setting. In this regard, as used herein, discussion of the use of laundry appliances in a commercial setting may generally refer to the use of the appliance in any location where one or more appliances are provided for temporary use by consumers or users who do not own the appliance(s). These commercial settings may include laundromats that include a large number of washers and dryers that are configured for pay-per-use operation, e.g., via cash, coins, digital currency, or other forms of payment. Additionally or alternatively, these commercial settings may include rental properties (e.g., short-term or long-term rental properties) in which a temporary, non-owner user or guest will have access to the appliance(s) for only a limited (e.g., predetermined) period of time.

For example, as shown in FIG. 1, washing machine appliance 100 may be located in a commercial laundromat along with other washing machine appliances, dryer appliances, etc. In some embodiments, each of the laundry appliances (e.g., washers or dryers) includes an appliance identifier or designation to identify a particular laundry appliance at a remote user device 152 or remote server 156. Such an identifier may be embedded or stored (e.g., within a corresponding controller 146 to be displayed at the display 144). Additionally or alternatively, the appliance identifier may be encoded in a bar code, such as a QR code applied or fixed to a portion of the appliance (e.g., on the corresponding cabinet or control panel). Further additionally or alternatively, the appliance identifier may include a serial number or MAC address of the washing machine appliance. Yet further additionally or alternatively, the appliance identifier may include a predetermined access code for adding a guest account to the notification table associated with a particular laundry appliance.

As explained briefly above, a user of a commercial laundry appliance may periodically wish to charge an electronic device that they intend to use while their loads of laundry are being cleaned and/or dried. Accordingly, aspects of the present subject matter are generally directed to a battery charging assembly 160 that may be associated with a commercial laundry appliance (e.g., such as washing machine appliance 100) to facilitate charging of a consumer device (e.g., such as remote user device 152). Although an example battery charging assembly 160 is described herein for charging remote device 152, it should be appreciated that other configurations of battery charging assembly 160 and other chargeable devices are possible and within the scope of the present subject matter.

According to the illustrated embodiment, battery charging assembly 160 may be mounted to cabinet 102 of washing machine appliance 100, e.g., on a front panel 130 of cabinet 102. More specifically, battery charging assembly 160 may include a docking station 162 that is positioned on or within cabinet 102. In general, docking station 162 may be configured to receive a charging pack 164 of battery charging assembly 160. More specifically, docking station 162 may be permanently affixed to cabinet 102 for securely receiving charging pack 164. For example, docking station 162 may be recessed within cabinet 102 such that it remains flush with front panel 130 of cabinet 102. Charging pack 164 may be removably received within docking station 162 such that an authorized user may remove charging pack 164 to charge remote device 152. By contrast, an unauthorized user may be prevented from accessing charging pack 164, as will be described in more detail below.

For example, battery charging assembly 160 may generally include a locking mechanism 170 that is configured for securing charging pack 164 within docking station 162. Locking mechanism 170 may include a protruding latch 172 that is received within an aperture 174 defined on charging pack 164. Accordingly, when a user inserts charging pack 164 into docking station 162, protruding latch 172 may snap into aperture 174 and may be locked in place to prevent removal of charging pack 164. It should be appreciated that other locking mechanisms are possible and within the scope of the present subject matter. For example, according to an alternative embodiment, battery charging assembly 160 may include a docking door (not shown) that is movable between an open position and a closed position to permit or restrict access, respectively, to charging pack 164 within docking station 162.

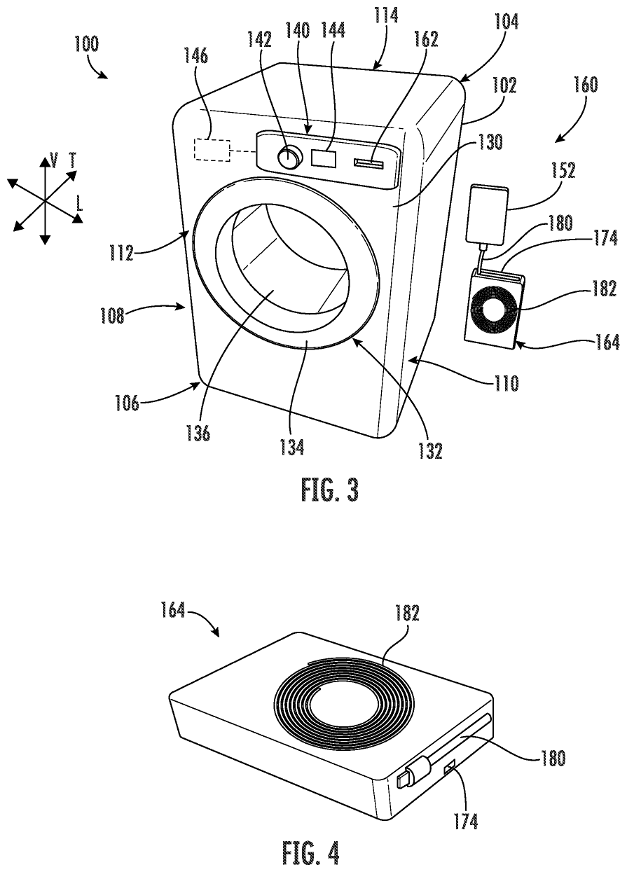

As explained briefly above, a user may pay a fee for credits to receive access to charging pack 164, e.g., to charge remote device 152. Upon receiving access authorization, the user may remove charging pack 164 and electrically couple charging pack 164 to remote device 152. For example, as best shown in FIGS. 3 and 4, charging pack 164 may include a wired connection 180 (e.g., such as a charging cable) that may be plugged into a port on remote device 152 for supplying remote device 152 with electrical power and charging an internal battery. According to still other embodiments, charging pack 164 may have an integrated wireless charging assembly 182 that is configured for selectively charging remote device 152 when remote device 152 was placed on charging pack 164 or within proximity of an associated charging coil.

Notably, a user may have consumed some or all energy within charging pack 164 prior to returning it to docking station 162. Accordingly, laundry appliance 100 may further include features for charging the charging pack 164. For example, battery charging assembly 160 may include a charging assembly 184 operably coupled to docking station 162 and being configured for charging the charging pack 164 when the charging pack 164 is installed in docking station 162. For example, charging assembly 184 may include an electrical docking port 186 for wired charging of charging pack 164. By contrast according to example embodiments, charging assembly 184 may include a wireless charging assembly (e.g., similar to wireless charging assembly 182) that is embedded within cabinet 102 for charging the charging pack 164 when installed in docking station 162.

Now that the construction of washing machine appliance 100 and battery charging assembly 160 according to exemplary embodiments have been presented, an exemplary method 200 of operating a washing machine appliance will be described. In this regard, method 200 provides an example method for renting a battery charger from a commercial laundry appliance, e.g., particularly a laundry appliance in a commercial, pay-per-use setting. Advantageously, method 200 may permit easy charging of a user's remote device 152 (e.g., a mobile phone) or other chargeable device. Although the discussion below refers to the exemplary method 200 of operating washing machine appliance 100, one skilled in the art will appreciate that the exemplary method 200 is applicable to the operation of a variety of other washing machine appliances, such as vertical axis washing machine appliances, dryer appliances, etc. In exemplary embodiments, the various method steps as disclosed herein may be performed by controller 146, remote server 156, remote user device 152, etc.

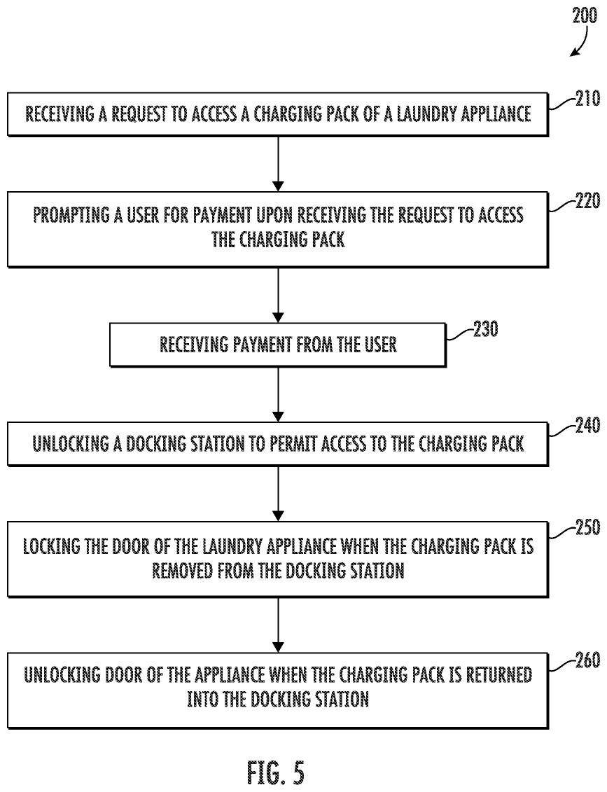

Referring now to FIG. 5, method 200 includes, at step 210, receiving a request to access a charging pack of a laundry appliance. In this regard, as explained above, a user of a commercial laundry appliance may wish to charge their cell phone while running operating cycles of the laundry appliance. Accordingly, step 210 may include a user requesting access, e.g., via control panel 140, through a software application on remote device 152, or in any other suitable manner. Upon receipt of the access request, method 200 may include prompting a user for payment. In this regard, laundry appliance 100 may charge for use of charging pack 164 and for the energy consumed while charging remote device 152. Step 230 may generally include receiving payment from the user. For example, a user may utilize a software application in remote device 152 to transmit funds through a bank or credit card, through laundromat credits, via account deposits, or any other suitable manner.

After a user has requested and paid for use of battery charging assembly 160, step 240 may include unlocking a docking station to permit access to the charging pack. In this regard, for example, controller 146 may actuate locking mechanism 170 to release charging pack 164. The user may then manually remove charging pack 164 from docking station 162 and may use it to charge remote device 152 (e.g., through wired connection 180 or wireless charging assembly 182). After a user has finished using charging pack 164, it may be returned to docking station 162 so that it may be recharged for future use.

Notably, in order to prevent theft or loss of charging pack 164, it may be desirable to prevent a user from finishing a laundry cycle or removing their clothes until the charging pack 164 has been returned to docking station 162. Accordingly, step 250 may generally include locking the door of the laundry appliance when charging pack 164 is removed from docking station 162. In this manner, a user must return charging pack 164 before retrieving their clothes. Step 260 may generally include unlocking the door of the appliance when the charging pack is returned into the docking station. According to example embodiments, controller 146 may assess how much energy was used by the remote device 152 and may charge the user a fee associated with that energy usage. After charging pack 164 is returned and the user finishes using laundry appliance 100, controller 146 may be further configured to lock the charging pack 164 in the docking station 162. In addition, controller 146 may begin a charging process (e.g., using charging assembly 184), thereby ensuring that charging pack 164 is fully charged for use by a subsequent user.

FIG. 5 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 200 are explained using washing machine appliance 100 as an example, it should be appreciated that these methods may be applied to the operation of any suitable washing machine appliance or pay-per-use laundry appliance.

As explained herein, aspects of the present subject matter are generally directed to a system where customers at a commercial laundry can rent portable mobile phone battery chargers. These portable chargers may be seamlessly integrated into the laundry machines. Users can initiate the renting process through a user interface panel or through a software application on their mobile phone. The software application may have an option to select a portable battery charger by checking a checkbox. Once a user starts a laundry cycle, the fee for the charger may be automatically deducted from the user's bank account or deposited funds. The charger may be powered by the commercial laundry machine itself. Before starting the cycle, users can retrieve the charger as it is locked in a battery bank locker. At the end of the wash cycle, users may be unable to retrieve their laundry unless they return the charger to the battery locker, ensuring its retrieval. Additionally, the portable charger may support wireless charging, offering an added level of convenience. The systems and methods described herein may allow customers to no longer worry about using their smartphones during long washing cycles. In addition, laundromat owners may expect to generate additional revenue by offering this add-on feature.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A laundry appliance operating in a commercial laundromat, the laundry appliance comprising:
a cabinet;
a tub positioned within the cabinet;
a basket rotatably mounted within the tub and defining a chamber configured for receiving a load of clothes;
a door rotatably mounted to the cabinet for providing selective access to the chamber; and
a battery charging assembly mounted to the cabinet, the battery charging assembly comprising:
a docking station positioned on or within the cabinet;
a charging pack removably received within the docking station; and
a charging assembly operably coupled to the docking station and being configured for charging the charging pack when the charging pack is installed in the docking station.

2. The laundry appliance of claim 1, wherein the battery charging assembly further comprises:
a locking mechanism for securing the charging pack within the docking station.

3. The laundry appliance of claim 2, wherein the locking mechanism comprises a protruding latch that is received within an aperture of the charging pack.

4. The laundry appliance of claim 2, wherein the locking mechanism comprises:
a docking door that is movable between an open position to permit access to the charging pack and a closed position to prevent access to the charging pack.

5. The laundry appliance of claim 1, further comprising a controller operably coupled to the battery charging assembly, the controller being configured to:
receive a request to access the charging pack; and
unlock the docking station to permit access to the charging pack.

6. The laundry appliance of claim 5, wherein the controller is further configured to:
prompt a user for payment upon receiving the request to access the charging pack; and
receive payment from the user prior to unlocking the docking station.

7. The laundry appliance of claim 5, wherein the controller is further configured to:
lock the door when the charging pack is removed from the docking station; and
unlock door when the charging pack is returned into the docking station.

8. The laundry appliance of claim 7, wherein the controller is configured to:
lock the charging pack in the docking station before unlocking the door of laundry appliance.

9. The laundry appliance of claim 1, wherein the charging pack comprises:
a wireless charging assembly for wirelessly charging a cell phone.

10. The laundry appliance of claim 1, wherein the charging pack comprises:
a charging cable configured for electrically coupling to a cell phone for charging the cell phone.

11. The laundry appliance of claim 1, wherein the docking station comprises:
an electrical docking port for wired charging of the charging pack.

12. The laundry appliance of claim 1, wherein the docking station comprises:
a wireless charging assembly for selectively charging the charging pack when the charging pack is installed in the docking station.

13. The laundry appliance of claim 1, wherein the docking station is recessed within the cabinet.

14. A method of operating a laundry appliance in a commercial laundromat, the laundry appliance comprising a tub positioned within a cabinet, a door rotatably mounted to the cabinet for providing selective access to the tub, and a battery charging assembly mounted to the cabinet and comprising a docking station positioned on or within the cabinet, a charging pack removably received within the docking station, and a charging assembly operably coupled to the docking station and being configured for charging the charging pack when the charging pack is installed in the docking station, the method comprising:
receiving a request to access the charging pack; and
unlocking the docking station to permit access to the charging pack.

15. The method of claim 14, further comprising:
prompting a user for payment upon receiving the request to access the charging pack; and
receiving payment from the user prior to unlocking the docking station.

16. The method of claim 14, wherein the laundry appliance further comprises a locking mechanism for securing the charging pack within the docking station, the method further comprising:
locking the door when the charging pack is removed from the docking station; and
unlocking door when the charging pack is returned into the docking station.

17. The method of claim 14, wherein the laundry appliance comprises an electrical docking port to charge the charging pack, the method comprising:
charging the charging pack using the electrical docking port when the charging back is installed within the docking station.

18. The method of claim 14, wherein the charging pack comprises:
a wireless charging assembly for wirelessly charging a cell phone or a charging cable configured for electrically coupling to a cell phone for charging the cell phone.

19. The method of claim 14, wherein the docking station comprises:
a wireless charging assembly for selectively charging the charging pack when the charging pack is installed in the docking station.

20. The method of claim 14, wherein the docking station is recessed within the cabinet.
